(19) United States
(12) Patent Application Publication
(10) Pub. No.: US 2025/0371960 A1
(43) Pub. Date: Dec. 4, 2025

(54) VISION ASSISTANCE FOR MISHAPS PREVENTION IN AN OVEN

(71) Applicant: WHIRLPOOL CORPORATION, BENTON HARBOR, MI (US)

(72) Inventors: Alessandro Gigante, Varese (IT); Vaishali Nandy, Kalamazoo, MI (US); Marco Casucci, Varese (IT); Stefano Masi, Varese (IT); Colleen Marie Rodriguez, Ann Arbor, MI (US)

(73) Assignee: WHIRLPOOL CORPORATION, BENTON HARBOR, MI (US)

(21) Appl. No.: 18/732,994

(22) Filed: Jun. 4, 2024

(51) Int. Cl. G08B 21/18; A47J 36/32; G06V 10/764; G06V 20/50; G06V 20/68

(52) U.S. Cl. CPC G08B 21/18; A47J 36/321; G06V 10/764; G06V 20/50; G06V 20/68

(57) ABSTRACT

A cooking appliance includes a body defining a cooking chamber and a sensor that monitors the cooking chamber. A control system is configured to detect an item of food within the cooking chamber with the sensor, and classify a type of the item of food from a list of classifications including at least grease generating, non-grease generating, or splatter generating. If the item of food is classified as grease generating or splatter generating, a splatter reduction alert or a placement alert is generated for a user to take a corrective action.

### FIELD OF THE DISCLOSURE

The present disclosure generally relates to a cooking appliance and, more particularly, a control and monitoring system of the cooking appliance that monitors food within a cooking cavity for characteristics of grease or splattering of foodstuff.

### BACKGROUND

Some cooking appliances incorporate assistive cooking technologies. These assistive cooking technologies may implement a catalog of pre-saved cooking cycles specifically designed for different types of food. Assistive cooking technologies are typically pre-saved or programmed instructions that do not provide dynamic recommendations or corrective actions before cooking or as food is being cooked. For example, as some types of food cook, grease is generated that can spill into an oven cavity if the food is not properly placed.

Accordingly, the present disclosure relates to a control and monitoring system of the cooking appliance that monitors food within a cooking cavity for characteristics of grease or splattering foodstuff generation.

### SUMMARY OF THE DISCLOSURE

According to one aspect of the present disclosure, a cooking appliance includes a body defining a cooking chamber and a sensor that monitors the cooking chamber. A control system is configured to detect an item of food within the cooking chamber with the sensor and classify a type of the item of food from a list of classifications including at least grease generating and non-grease generating. If the item of food is classified as grease generating, it is determined if a grease catching vessel is located under the item of food. If the grease catching vessel is not located under the item of food, a placement alert is generated to notify a user to place the grease catching vessel under the item of food.

According to another aspect of the present disclosure, a cooking appliance includes a body defining a cooking chamber and a sensor monitoring the cooking chamber. A control system is configured to detect an item of food within the cooking chamber with the sensor and monitor the item of food for the generation of grease. If the item of food is generating grease, it is determined if a grease catching vessel is located under the item of food. If the grease catching vessel is not located under the item of food, a placement alert is generated to notify a user to place the grease catching vessel under the item of food.

According to yet another aspect of the present disclosure, a cooking appliance includes a body defining a cooking chamber and a sensor monitoring the cooking chamber. A control system is configured to detect an item of food within the cooking chamber with the sensor and monitor the item of food for the generation of splattering foodstuff. If the item of food is splattering foodstuff, a splatter reduction alert is generated for a user to take a corrective action.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front view of a cooking appliance with a grease monitoring system, according to an aspect of the present disclosure;

FIG. 2 is a front view of a cooking chamber with a grease monitoring system, according to an aspect of the present disclosure;

FIG. 3 is a front perspective view of an item of food splattering foodstuff within a cooking vessel, according to an aspect of the present disclosure;

FIG. 4 is a schematic view of a control system for a cooking appliance, according to an aspect of the present disclosure;

FIG. 5 is a schematic view of a food classification dictionary, according to an aspect of the present disclosure;

FIG. 6 is a front view of an image containing an item of food generating grease, according to an aspect of the present disclosure;

FIG. 7 illustrates a first method of monitoring a cooking chamber for grease dripping conditions, according to an aspect of the present disclosure;

FIG. 8 illustrates a second method of monitoring a cooking chamber for grease dripping conditions, according to an aspect of the present disclosure; and

FIG. 9 illustrates a third method of monitoring a cooking chamber for food splattering conditions, according to an aspect of the present disclosure.

The components in the figures are not necessarily to scale, emphasis instead being placed upon illustrating the principles described herein.

### DETAILED DESCRIPTION

The present illustrated embodiments reside primarily in a control and monitoring system of the cooking appliance that monitors food within a cooking cavity for characteristics of grease. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

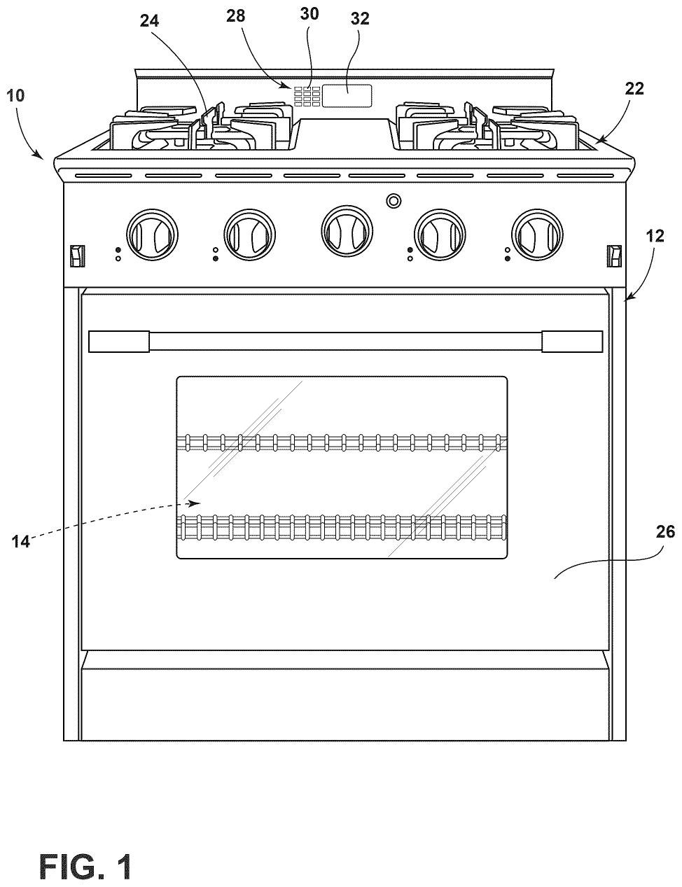

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer and/or user, and the term “rear” shall refer to the surface of the element further from the intended viewer and/or user. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1-4, reference numeral 10 generally designates a cooking appliance. The cooking appliance 10 includes a body 12 defining a cooking chamber 14 and a sensor 16 that monitors the cooking chamber 14. A control system 100 (e.g., a processor 104) is configured to detect an item of food 18 within the cooking chamber 14 with the sensor 16, and classify a type of the item of food 18 from a list of classifications including at least grease generating and non-grease generating. If the item of food 18 is classified as grease generating, it is determined if a grease catching vessel 20 is located under the item of food 18. If the grease catching vessel 20 is not located under the item of food 18, a placement alert is generated to notify a user to place the grease catching vessel 20 under the item of food 18.

Generally speaking, the systems, methods, and functions described herein assist the user while cooking the item of food 18 by preventing certain mishaps caused by grease generation. According to one aspect, the control system 100 (e.g., the processor 104) may initially classify, via data from the sensor 16, the item of food 18 between at least the grease generating classification and the non-grease generating classification. According to another aspect, the control system 100 (e.g., the processor 104) may detect, via data from the sensor 16, if the item of food 18 is generating grease. Therefore, it should be appreciated that the systems, methods, and functions described herein may operate under one or both of the initial classification and the detection aspects. As will be described in greater detail below, if the grease catching vessel 20 is located under the item of food 18, the control system 100 (e.g., the processor 104) may be further configured to detect if a grease catching liquid, such as water, that cools and inhibits smoke caused by the grease is located in the grease catching vessel 20.

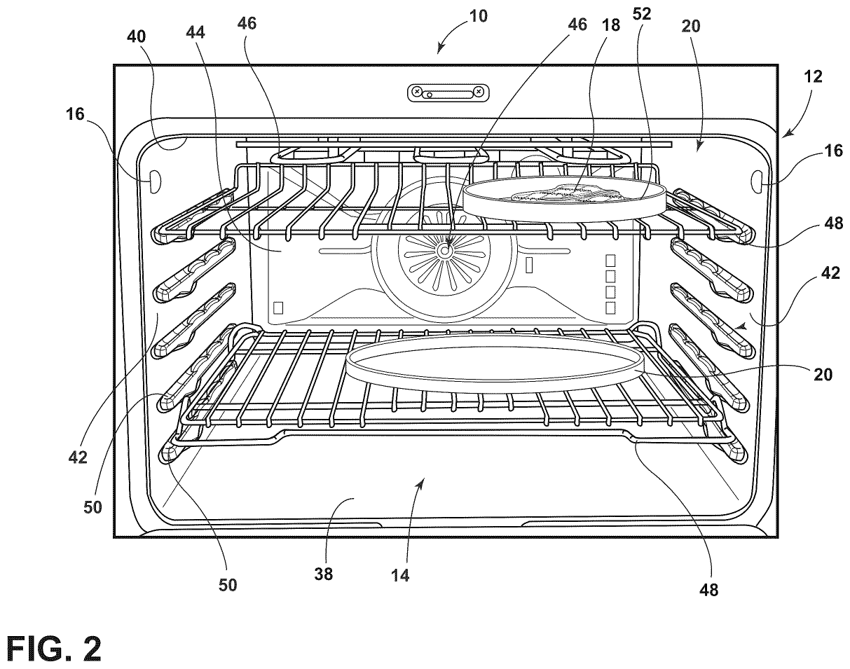

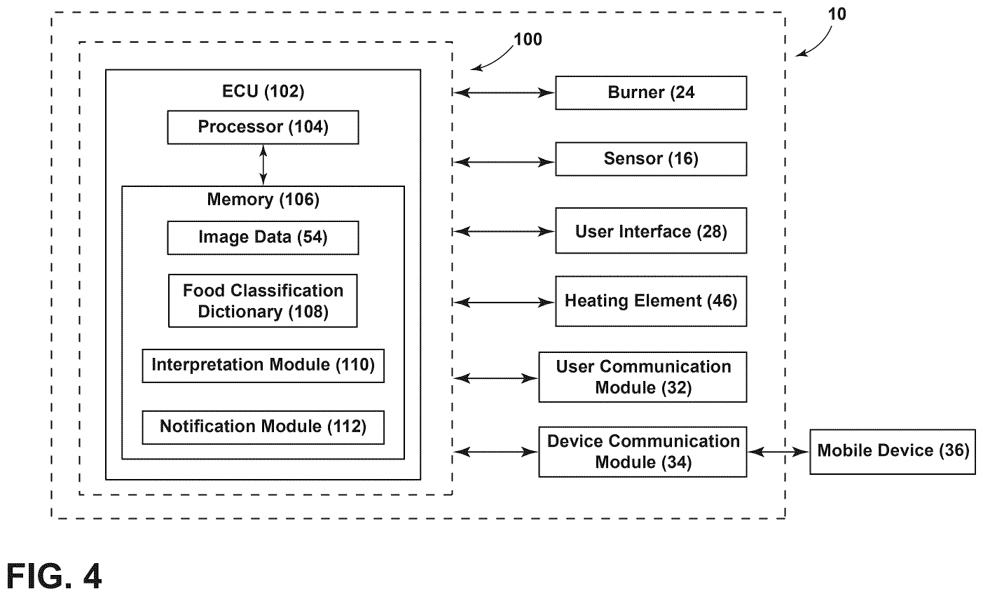

With reference now to FIGS. 1 and 2, the cooking appliance 10 may employ a variety of heating technologies, such as induction heating, electric heating, gas heating, and heating that employs all fuel types. Further, the cooking appliance 10 may include a cooktop 22 including one or more burners 24 that employ any of the above-referenced heating technologies. The cooking chamber 14 may be accessed via a door 26 that includes an open position and a closed position. The cooking appliance may further include a user interface 28 that includes user inputs 30, such as touchpads, buttons, knobs, speakers, voice recognition functionality, and/or the like. The user interface 28 may further includes a user communication module 32, such as a display, a speaker, and/or one or more lighting modules that effectuate alerting and/or notifying the user. In some embodiments, the user interface 28 may further include a device communication module 34 that wirelessly connects to a mobile device 36 (FIG. 4), such as a mobile phone, a tablet, and/or the like. In this manner, when an alert or notification is generated, it may be generated locally via the user communication module 32 and/or remotely via communication between the device communication module 34 and the mobile device 36.

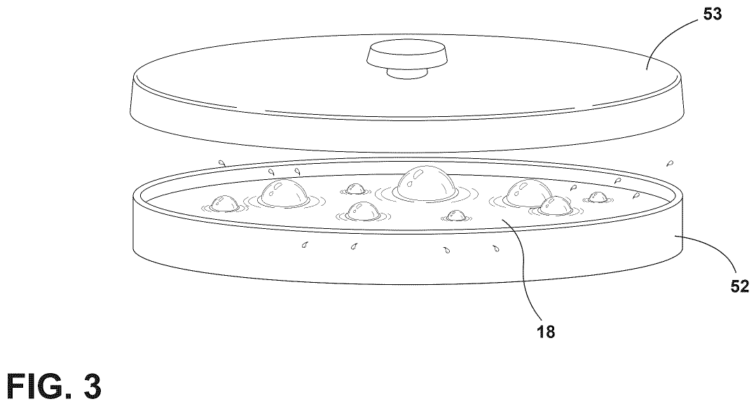

With continued reference to FIGS. 1 and 2, the cooking chamber 14 is generally defined by a floor 38 and a ceiling 40 spaced by sidewalls 42 and a back wall 44. A heating element 46 is generally proximate the back wall 44 and/or the ceiling 40. The cooking appliance 10 typically includes one or more racks 48 (e.g., a top rack and a bottom rack) for placing the item of food 18. The cooking chamber 14 (e.g., the sidewalls 42 and/or back wall 44) may define rack holding structures 50 for locating the one or more racks 48 at different positions relative to a floor 38 and ceiling 40. The rack holding structures 50 may include projections or recesses that hold one of the racks 48. As depicted, the racks 48 are generally grid-shaped and, as a result, grease from the item of food 18 can drip through the grid and onto the floor 38. In a similar manner, the item of food 18 can splatter foodstuff, food splatter can both fall through the grid and onto the floor 38, splatter on the ceiling 40, the sidewalls 42, and the back wall 44. As appreciated, food splatter can cause negative impacts to the cooking operation. The food item 18 may be placed directly on the rack 48 or in a cooking vessel 52, such as the cooking vessel 52 depicted in FIG. 3. The cooking vessel 52 may include a lid 53 that optionally covers the item of food 18 to prevent food splatter. As will be described in greater detail below, the control system 100 (e.g., the processor 104) may be configured to determine if the lid 53 is covering the food item 18 and generate an alert if the food item 18 is splattering foodstuff and the lid 53 is not placed or improperly placed on the cooking vessel 52.

With reference now to FIGS. 2 and 3, in some embodiments, the sensor 16 may be located within the cooking chamber 14, outside of the cooking chamber 14 and behind one or more of the floor 38, the ceiling 40, the sidewalls 42, and/or the back wall 44 (e.g., and oriented towards the cooking chamber 14 with an exposure hole and/or transparent element), and/or outside of the cooking appliance 10 (e.g., on the door 26). As used herein, the term “sensor” may refer to one or more of any type of sensing module that is capable of extracting data for the control system 100 (e.g., the processor 104) to at least one of classify the item of food 18 and detect the generation of splattering or dripping. Further, the sensor 16 may include two or more sensors located in different locations relative to the cooking chamber 14 to ensure line-of-sight to the item of food 18, particularly in scenarios where a cooking vessel 52 is employed.

With continued reference to FIGS. 2 and 3, the sensor 16 may be configured as one or more imager modules that capture image data 54 within the cooking chamber 14. In some embodiments, the one or more imager modules may include a thermal camera that detects infrared energy (heat) and converts it into image data 54. In some embodiments, the one or more imager modules may be used in conjunction with one or more light sources. For example, the one or more light sources may be configured to generate light in a visible or non-visible spectrum (e.g., infrared or near infrared spectrum) and the imager module may be configured to capture image data 54 in the visible or non-visible spectrum associated with the light source. The one or more imager modules may be configured to gather image data in any number of frames-per-second, such that classification and detection is near real-time to prevent and/or minimize the dripping and splatter of foodstuff. The control system 100 (e.g., the processor 104) may be configured to trigger the one or more imager modules upon an event, such as when the door 26 is opened, interaction with the user interface 28 (e.g., user inputs 30 or through the mobile device 36), or when the heating element 46 is energized (e.g., preheated).

With reference now to FIG. 4, the control system 100 is schematically illustrated. The control system 100 may include an electronic control unit (ECU) 102. The ECU 102 may include the processor 104 and a memory 106. The processor 104 may include any suitable processor 104. Additionally, or alternatively, the ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid-state) memory, other non-transitory storage mediums, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the control system 100. The one or more sensors 16 (e.g., imager module and light source), the user interface 28, and the heating element 46 may therefore be controlled by and/or receive instructions from the ECU 102. The memory 106 may therefore include the image data 54, a food classification dictionary 108, an image interpretation module 110, and a notification module 112.

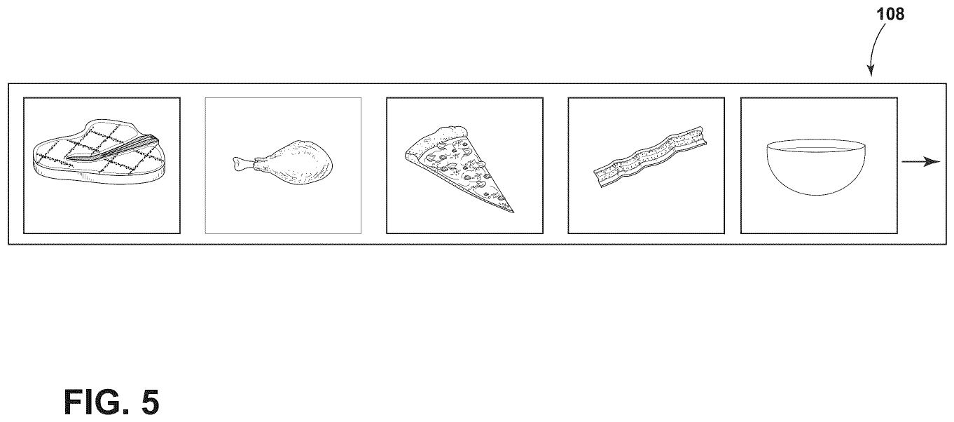

With reference now to FIGS. 4 and 5, the food classification dictionary 108 may include pre-saved food characteristics relating to shape, color, and size that can compared to characteristics of the food item 18 that are extracted by the image data 54. For example, and while not an exhaustive list, steaks, burgers, other types of meat, and/or food with high fat and oil contents that are known to generate grease typically have defining characteristics that can be perceived and/or extracted by the control system 100 (e.g., the processor 104). This grease can drip from the food item 18 or splatter at high temperatures. In addition, other food items 18, with or without grease generation qualities, can be susceptible to splatter. For example, soups and other liquids are known to splatter at high temperatures. In some embodiments, the classification dictionary 108 may include instructions to classify the item of food 18 based, at least in part, on the cooking vessel 52. For example, liquids contained within a bowl or other type of cooking vessel 52 may be classified, at least in part, based on the cooking vessel 52. Further, the food classification dictionary 108 may include positional parameter instructions, such as detecting the location and orientation of the food item 18 with respect to the sensor 16 (e.g., imager module). In this manner, the perspective orientation of the image data 54 can be determined for making the classification more accurate. In some embodiments, the pre-saved food characteristics may include multiple orientations saved together or categorized in discrete files/memory partitions. By comparing the extracted defining characteristics with the pre-saved characteristics, the food item 18 can be classified between at least the grease generating classification and the non-grease generating classification. The grease generating classification may include a dripping classification and/or a splattering classification. While grease generating classification is used herein as an example, it should be appreciated that the generic terms foodstuff splattering or foodstuff dripping classifications can also be utilized herein and may generally refer to any item of food 18 that may drip or splatter within the cooking chamber 14. The foodstuff splattering or foodstuff dripping classifications can be classified and/or detected in accordance with the systems, methods, and features described herein.

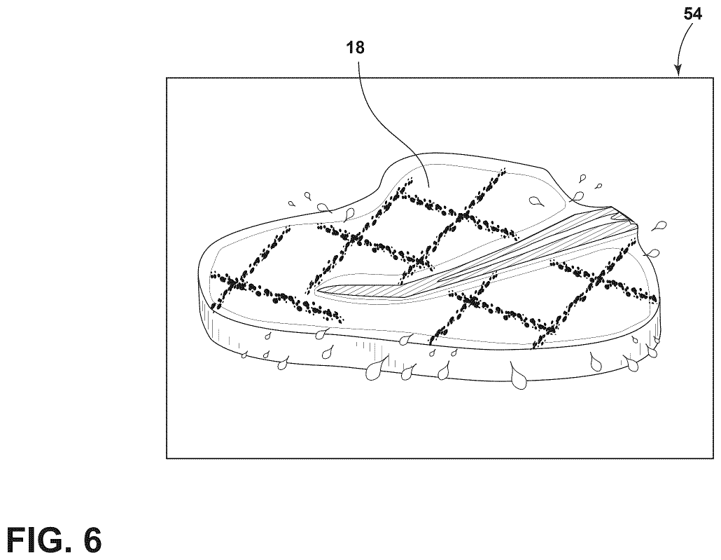

With reference now to FIGS. 4 and 6, in addition, or alternatively to classification, the control system 100 (e.g., the processor 104) may utilize the image interpretation module 110. The image interpretation module 110 may include instructions to detect detectable characteristics of grease generation pre or during dripping or splattering based on the image data 54. For example, when the food item 18 is heated and begins to generate grease, the surface of the food item 18 may exhibit the detectable characteristics, such as sheen, visible grease expelling from the surface of the food item 18, and/or the like. The image interpretation module 110 may likewise include parameters for the detection and recognition of the presence and location of the grease catching vessel 20 and grease catching liquid in the grease catching vessel 20. In addition, the image interpretation module 110 may further and/or alternatively include parameters for the detection and recognition of the presence of the cooking vessel 52, if the food item 18 is placed therein, and if the lid 53 is placed or improperly placed on the cooking vessel 52. Improper placement may be associated with a situation where the lid 53 is only partially covering the cooking vessel 52 and a detectable level of food splatter is escaping from the cooking vessel 52. Further, it should be appreciated that, in some scenarios, the detection and recognition of food splatter may be independent of the cooking vessel 52, and the term lid 53 may be more generally associated with a covering (e.g., a sheet of aluminum foil).

The notification module 112 may include parameters on when the control system 100 (e.g., the processor 104) generates the alert the user. The parameters may include several independent conditions on when to generate the alert and the alert may be different based on the independent condition detected. For example, in the event that the grease catching vessel 20 is not located under the item of food 18, the control system 100 (e.g., the processor 104) may generate a placement alert. In the event that the grease catching liquid is not in the grease catching vessel 20, the control system 100 (e.g., the processor 104) may generate a grease catching liquid alert (e.g., a water alert). In the event that the item of food 18 is splattering foodstuff, the control system 100 (e.g., the processor 104) may generate a splatter reduction alert. In some embodiments, the placement alert, the grease catching liquid alert (e.g., a water alert), and the splatter reduction alert may be different. For example, the alerts may be distinct by any of a combination of auditory (e.g., frequency, amplitude, vocal commands) or visual (e.g., via graphics, colors, or pulsing of light via user communication module 32) distinctions. Further, these alerts may be carried out (e.g., via device communication module 34) through the mobile device 36.

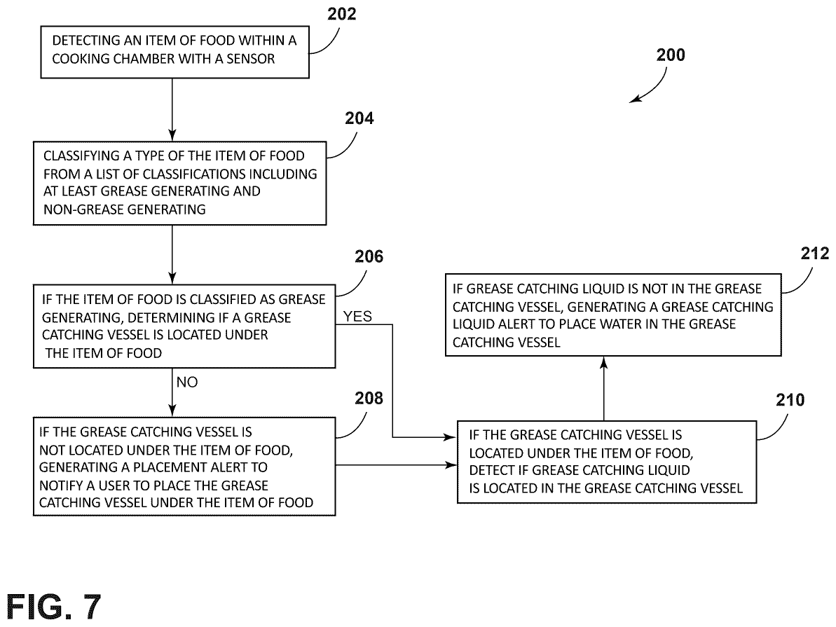

With reference now to FIG. 7, a first method 200 of monitoring a cooking chamber for grease dripping conditions is illustrated. In some embodiments, the first method 200 may be carried out by, for example, the cooking appliance 10 and control system 100 depicted in FIGS. 1-6. The first method 200 includes, at step 202, detecting an item of food within a cooking chamber with a sensor. At step 204, the first method 200 may include classifying a type of the item of food from a list of classifications including at least grease generating and non-grease generating. At step 206, the first method 200 may include, if the item of food is classified as grease generating, determining if a grease catching vessel is located under the item of food. At step 208, the first method 200 may include, if the grease catching vessel is not located under the item of food, generating a placement alert to notify a user to place the grease catching vessel under the item of food. At step 210, the first method 200 may further include, if the grease catching vessel is located under the item of food, detect if grease catching liquid (e.g., water) is located in the grease catching vessel. At step 212, the first method 200 may further include, if grease catching liquid is not in the grease catching vessel, generating a grease catching liquid alert (e.g., a water alert) to place water in the grease catching vessel. The first method 200 may include continually monitoring both the food item and the grease catching vessel (e.g., for dry out conditions of the grease catching liquid). Once it is determined that the grease catching vessel is dry, a subsequent grease catching liquid alert (e.g., a water alert) may be generated. The monitoring, classifying, and subsequent alerts and signals provided in method 200 may include those described in relation to the cooking appliance 10.

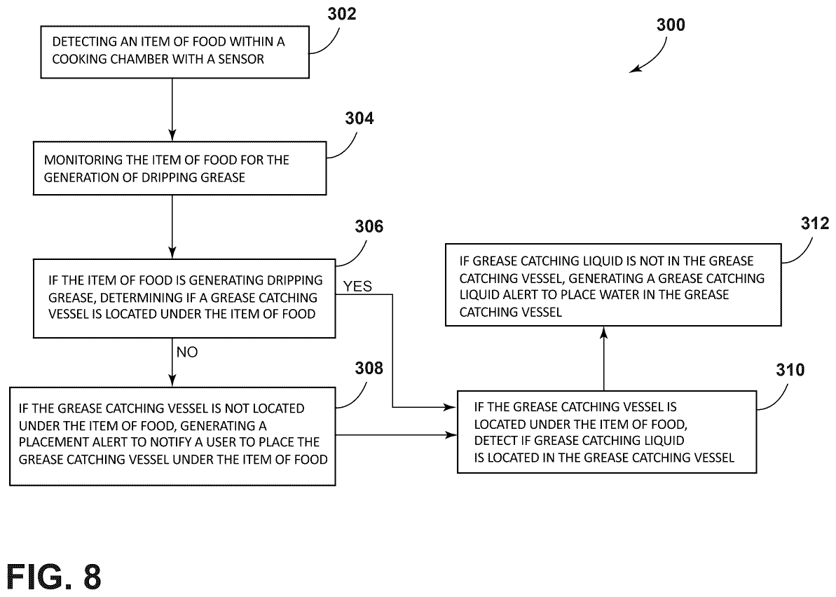

With reference now to FIG. 8, a second method 300 of monitoring a cooking chamber for grease dripping conditions is illustrated. In some embodiments, the second method 300 may be triggered if an item of food is not classified as grease generating from the first method 200 and/or the second method 300 may be independent of the first method 200. Similar to the first method 200, the second method 300 may be carried out by, for example, the cooking appliance 10 and control system 100 depicted in FIGS. 1-6. The second method 300 includes, at step 302, detecting an item of food within a cooking chamber with a sensor. At step 304, the second method 300 may include monitoring the item of food for the generation of dripping grease. At step 306, the second method 300 may include, if the item of food is generating dripping grease, determining if a grease catching vessel is located under the item of food. At step 308, the second method 300 may include, if the grease catching vessel is not located under the item of food, generating a placement alert to notify a user to place the grease catching vessel under the item of food. At step 310, the second method 300 may further include, if the grease catching vessel is located under the item of food, detect if grease catching liquid (e.g., water) is located in the grease catching vessel. At step 312, the second method 300 may further include, if grease catching liquid is not in the grease catching vessel, generating a grease catching liquid alert (e.g., a water alert) to place water in the grease catching vessel. The second method 300 may include continually monitoring both the food item and the grease catching vessel (e.g., for dry out conditions of the grease catching liquid). Once it is determined that the grease catching vessel is dry, a subsequent grease catching liquid alert (e.g., a water alert) may be generated. The monitoring, classifying, and subsequent alerts and signals provided in method 300 may include those described in relation to the cooking appliance 10.

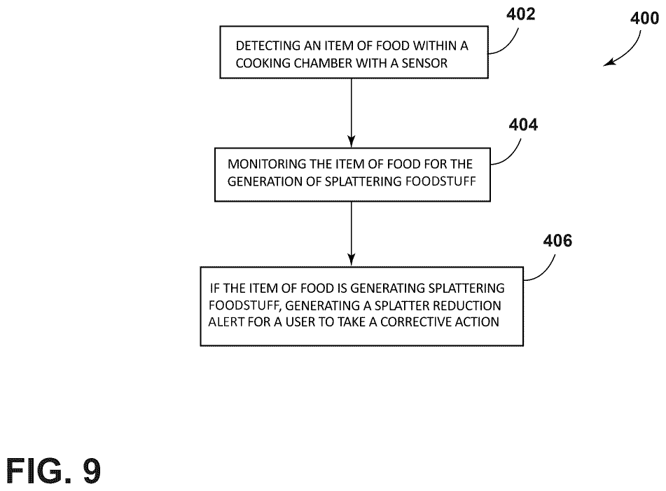

With reference now to FIG. 9, a third method 400 of monitoring a cooking chamber for food splattering conditions is illustrated. Similar to the first and second methods 200, the third method 400 may be carried out by, for example, the cooking appliance 10 and control system 100 depicted in FIGS. 1-6. The third method 400 includes, at step 402, detecting an item of food within a cooking chamber with a sensor. At step 404, the third method 400 may include monitoring the item of food for the generation of splattering foodstuff. At step 406, the third method 400 may include, if the item of food is generating splattering foodstuff, generating a splatter reduction alert for a user to take a corrective action. The corrective action may include placing a lid (e.g., a cover) over the item of food. The monitoring, classifying, and subsequent alerts and signals provided in method 400 may include those described in relation to the cooking appliance 10.

With reference now to FIGS. 1-9, it should be appreciated that the systems and methods described herein can be used independently or in conjunction. For example, the food item 18 may be classified and/or detected as grease generating (e.g., dripping and/or splattering) and the control system 100 (e.g., the processor 104) may generate one or more alerts for placement of the grease catching vessel 20, the lid 53 (e.g., a cover), and grease catching liquid (e.g., water) simultaneously or sequentially, as a single alert, multiple alerts, and/or as the grease conditions are detected.

The disclosure herein is further summarized in the following paragraphs and is further characterized by combinations of any and all of the various aspects described therein.

According to one aspect of the present disclosure, a cooking appliance includes a body defining a cooking chamber and a sensor that monitors the cooking chamber. A control system is configured to detect an item of food within the cooking chamber with the sensor, and classify a type of the item of food from a list of classifications including at least grease generating and non-grease generating. If the item of food is classified as grease generating, it is determined if a grease catching vessel is located under the item of food. If the grease catching vessel is not located under the item of food, a placement alert is generated to notify a user to place the grease catching vessel under the item of food.

According to another aspect, a sensor is configured as an imager module, and a control system classifies a type of an item of food with image data captured by the imager module.

According to yet another aspect, a control system is configured to if a grease catching vessel is located under an item of food, detect if water is located in the grease catching vessel. If water is not in the grease catching vessel, a water alert is generated to place water in the grease catching vessel.

According to still yet another aspect, a placement alert is different than a water alert.

According to another aspect, a control system is configured to detect if an item of food is splattering foodstuff, and if the item of food is splattering foodstuff, generate a splatter reduction alert for a user to take a corrective action.

According to yet another aspect, a splatter reduction alert includes a notification to cover an item of food.

According to still yet another aspect, a splatter reduction alert includes a notification to decrease a temperature within a cooking chamber.

According to another aspect, a sensor is located within a cooking chamber.

According to another aspect of the present disclosure, a cooking appliance includes a body defining a cooking chamber and a sensor monitoring the cooking chamber. A control system is configured to detect an item of food within the cooking chamber with the sensor, and monitor the item of food for the generation of grease. If the item of food is generating grease, it is determined if a grease catching vessel is located under the item of food. If the grease catching vessel is not located under the item of food, a placement alert is generated to notify a user to place the grease catching vessel under the item of food.

According to another aspect, a sensor is configured as an imager module, and a control system is configured to detect if an item of food is generating grease with image data captured by the imager module.

According to yet another aspect, a control system is configured to, if a grease catching vessel is located under an item of food, detect if water is located in the grease catching vessel. If water is not in the grease catching vessel, a water alert is generated to place water in the grease catching vessel.

According to yet another aspect, a control system is configured to detect if an item of food is splattering foodstuff, and if the item of food is splattering foodstuff, generate a splatter reduction alert for a user to take a corrective action.

According to another aspect, a splatter reduction alert includes a notification to cover an item of food or decrease a temperature within a cooking chamber.

According to yet another aspect, an imager module is located within a cooking chamber.

According to yet another aspect of the present disclosure, a cooking appliance includes a body defining a cooking chamber and a sensor monitoring the cooking chamber. A control system is configured to detect an item of food within the cooking chamber with the sensor, and monitor the item of food for the generation of splattering foodstuff. If the item of food is splattering foodstuff, a splatter reduction alert is generated for a user to take a corrective action.

According to another aspect, a splatter reduction alert includes a notification to cover an item of food.

According to yet another aspect, a splatter reduction alert includes a notification to decrease a temperature within a cooking chamber.

According to another aspect, a sensor is configured as an imager module, and a control system is configured to detect if an item of food is generating splattering foodstuff with image data captured by the imager module.

According to another aspect, an imager module is located within the cooking chamber.

According to yet another aspect, a control system is configured to monitor an item of food for the generation of dripping grease, and, if the item of food is generating dripping grease, determine if a grease catching vessel is located under the item of food. If the grease catching vessel is not located under the item of food, a placement alert is generated to notify a user to place the grease catching vessel under the item of food.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A cooking appliance, comprising:
a body defining a cooking chamber;
a sensor monitoring the cooking chamber; and
a control system configured to:
detect an item of food within the cooking chamber with the sensor;
classify a type of the item of food from a list of classifications including at least grease generating and non-grease generating;
if the item of food is as classified grease generating, determine if a grease catching vessel is located under the item of food; and
if the grease catching vessel is not located under the item of food, generate a placement alert to notify a user to place the grease catching vessel under the item of food.

2. The cooking appliance of claim 1, wherein the sensor is configured as an imager module, and the control system classifies the type of the item of food with image data captured by the imager module.

3. The cooking appliance of claim 1, wherein the control system is further configured to:
if the grease catching vessel is located under the item of food, detect if water is located in the grease catching vessel; and
if water is not in the grease catching vessel, generate a water alert to place water in the grease catching vessel.

4. The cooking appliance of claim 3, wherein the placement alert is different than the water alert.

5. The cooking appliance of claim 1, wherein the control system is further configured to:
detect if the item of food is splattering foodstuff; and
if the item of food is splattering foodstuff, generate a splatter reduction alert for the user to take a corrective action.

6. The cooking appliance of claim 5, wherein the splatter reduction alert includes a notification to cover the item of food.

7. The cooking appliance of claim 5, wherein the splatter reduction alert includes a notification to decrease a temperature within the cooking chamber.

8. The cooking appliance of claim 1, wherein the sensor is located within the cooking chamber.

9. A cooking appliance, comprising:
a body defining a cooking chamber;
a sensor monitoring the cooking chamber; and
a control system configured to:
detect an item of food within the cooking chamber with the sensor;
monitor the item of food for a generation of grease;
if the item of food is generating grease, determine if a grease catching vessel is located under the item of food; and
if the grease catching vessel is not located under the item of food, generate a placement alert to notify a user to place the grease catching vessel under the item of food.

10. The cooking appliance of claim 9, wherein the sensor is configured as an imager module, and the control system is configured to detect if the item of food is generating grease with image data captured by the imager module.

11. The cooking appliance of claim 10, wherein the control system is further configured to:
if the grease catching vessel is located under the item of food, detect if water is located in the grease catching vessel; and
if water is not in the grease catching vessel, generate a water alert to place water in the grease catching vessel.

12. The cooking appliance of claim 10, wherein the control system is further configured to:
detect if the item of food is splattering foodstuff; and
if the item of food is splattering foodstuff, generate a splatter reduction alert for the user to take a corrective action.

13. The cooking appliance of claim 12, wherein the splatter reduction alert includes a notification to cover the item of food or decrease a temperature within the cooking chamber.

14. The cooking appliance of claim 10, wherein the imager module is located within the cooking chamber.

15. A cooking appliance, comprising:
a body defining a cooking chamber;
a sensor monitoring the cooking chamber; and
a control system configured to:
detect an item of food within the cooking chamber with the sensor;
monitor the item of food for a generation of splattering foodstuff; and
if the item of food is splattering foodstuff, generate a splatter reduction alert for a user to take a corrective action.

16. The cooking appliance of claim 15, wherein the splatter reduction alert includes a notification to cover the item of food.

17. The cooking appliance of claim 15, wherein the splatter reduction alert includes a notification to decrease a temperature within the cooking chamber.

18. The cooking appliance of claim 15, wherein the sensor is configured as an imager module, and the control system is configured to detect if the item of food is generating splattering foodstuff with image data captured by the imager module.

19. The cooking appliance of claim 18, wherein the imager module is located within the cooking chamber.

20. The cooking appliance of claim 15, wherein the control system is further configured to:
monitor the item of food for a generation of dripping grease;
if the item of food is generating dripping grease, determine if a grease catching vessel is located under the item of food; and
if the grease catching vessel is not located under the item of food, generate a placement alert to notify the user to place the grease catching vessel under the item of food.
